(19) United States
(12) Patent Application Publication
(10) Pub. No.: US 2024/0227149 A1
(43) Pub. Date: Jul. 11, 2024

(54) PNEUMATIC TOOL

(71) Applicant: Crown Equipment Corporation, New Bremen, OH (US)

(72) Inventors: Kristopher Michael Hyde, New Bremen, OH (US); Randy D. Kuess, Celina, OH (US); Greg Edward Uhlenhake, St. Henry, OH (US); Christopher Dale Moorman, Celina, OH (US); Mark Joseph Stammen, St. Henry, OH (US)

(21) Appl. No.: 18/535,293

(22) Filed: Dec. 11, 2023

Related U.S. Application Data
(60) Provisional application No. 63/479,051, filed on Jan. 9, 2023.

(51) Int. Cl. B25F 5/02

(52) U.S. Cl. CPC B25F 5/02

(57) ABSTRACT

A pneumatic tool includes a body portion, an inlet port for delivering air to the body portion, a first handle, and a second handle. The second handle includes an exhaust port for discharging air from the body portion.

### CROSS REFERENCE TO RELATED APPLICATION

This application claims the benefit of U.S. Provisional Patent Application Ser. No. 63/479,051, filed Jan. 9, 2023, entitled “PNEUMATIC TOOL”, attorney docket 2211/CRN 1064 MA, the entire disclosure of which is hereby incorporated by reference herein.

### FIELD

The present disclosure relates to a handle for a pneumatic tool that includes an air exhaust port.

### BACKGROUND

Pneumatic tools typically include an inlet port for introducing air to the tool and exhaust ports or holes for discharging air from the tool. Such tools may also include a primary handle that may include various controls, and a secondary handle that is intended to be grasped by the user for proper operation of the tool.

### SUMMARY

In accordance with one aspect, a pneumatic tool is provided comprising a body portion, an inlet port for delivering air to the body portion, a first handle coupled to the body portion, and a second handle coupled to the body portion. The second handle comprises an exhaust port for discharging air from the body portion.

The exhaust port may comprise an outlet valve mechanism and an actuator that is actuatable by an operator to open the outlet valve mechanism such that the air can be discharged from the exhaust port. The actuator may comprise a lever located on the second handle or an arm member having a top portion that is located above the body portion.

The outlet valve mechanism may comprise a spring valve assembly that is biased toward a closed position unless the actuator is being actuated by the operator.

The pneumatic tool may not operate or operate at a reduced capacity if the actuator is not being actuated by the operator.

The tool may comprise no other exhaust ports than the one provided in the second handle.

The inlet port may be provided in the first handle, and may comprise an inlet valve mechanism and another actuator that is actuatable by an operator to open the inlet valve mechanism such that the air can be delivered into the body portion via the inlet port. The other actuator may comprise a lever located on the first handle. The inlet valve mechanism may comprise a spring valve assembly that is biased toward a closed position unless the other actuator is being actuated by the operator.

The pneumatic tool may further comprise a work component coupled to the body portion.

The first and second handles may respectively extend from different sides of the body portion.

In accordance with another aspect, a pneumatic tool is provided comprising a body portion, a first actuator, a second actuator, and a pneumatic circuit. The pneumatic circuit comprises an inlet valve mechanism for introducing air into the body portion, an outlet valve mechanism for discharging air from the body portion, and a tool actuator. The first actuator is coupled to the inlet valve mechanism and the second actuator is coupled to the outlet valve mechanism. The first actuator and second actuator are both actuated to activate the tool actuator.

The outlet valve mechanism may comprise a spring valve assembly that is biased toward a closed position unless the second actuator is being actuated by an operator.

The inlet valve mechanism may comprise a spring valve assembly that is biased toward a closed position unless the first actuator is being actuated by an operator.

The pneumatic tool may further comprise a first handle coupled to the body portion on a first side thereof, wherein the first actuator is located on the first handle.

The pneumatic tool may further comprise a second handle coupled to the body portion on a second side thereof different than the first side, wherein the second actuator is located on the second handle.

The first handle may include an inlet port for delivering air to the body portion.

The second handle may include an exhaust port for discharging air from the body portion. The tool may comprise no other exhaust ports than the one provided in the second handle.

The second actuator may comprise a lever or an arm member having a top portion that is located above the body portion.

The pneumatic tool may further comprise a work component coupled to the body portion.

The pneumatic tool may not operate or operate at a reduced capacity if the tool actuator is not activated.

In accordance with yet another aspect, a handle is provided for a pneumatic tool. The handle comprises an exhaust port for communication with an exhaust opening in the pneumatic tool. The exhaust port comprises an outlet valve mechanism and an actuator that is actuatable by an operator to open the outlet valve mechanism such that air from the tool can be discharged from the exhaust port.

The actuator may comprise a lever or an arm member having a top portion that is located above a body portion of the pneumatic tool when used on the pneumatic tool.

The outlet valve mechanism may comprise a spring valve assembly that is biased toward a closed position unless the actuator is being actuated by the operator.

### BRIEF DESCRIPTION OF THE DRAWINGS

FIGS. 1-4 illustrate a pneumatic tool according to embodiments;

FIG. 5 is an exploded view of an outlet valve mechanism of the pneumatic tool according to FIGS. 1-4;

FIGS. 6-9 illustrate a pneumatic tool according to embodiments;

FIG. 10 is an exploded view of an outlet valve mechanism of the pneumatic tool according to FIGS. 6-9; and

FIG. 11 is a schematic diagram of a pneumatic tool according to embodiments.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. It should be understood that multiple combinations of the embodiments described and shown are contemplated and that a particular focus on one embodiment does not preclude its inclusion in a combination of other described embodiments. Numerous alternative embodiments could also be implemented, using either current technology or technology developed after the filing date of this patent, which would still fall within the scope of the claims. All publications and patents cited herein are incorporated herein by reference.

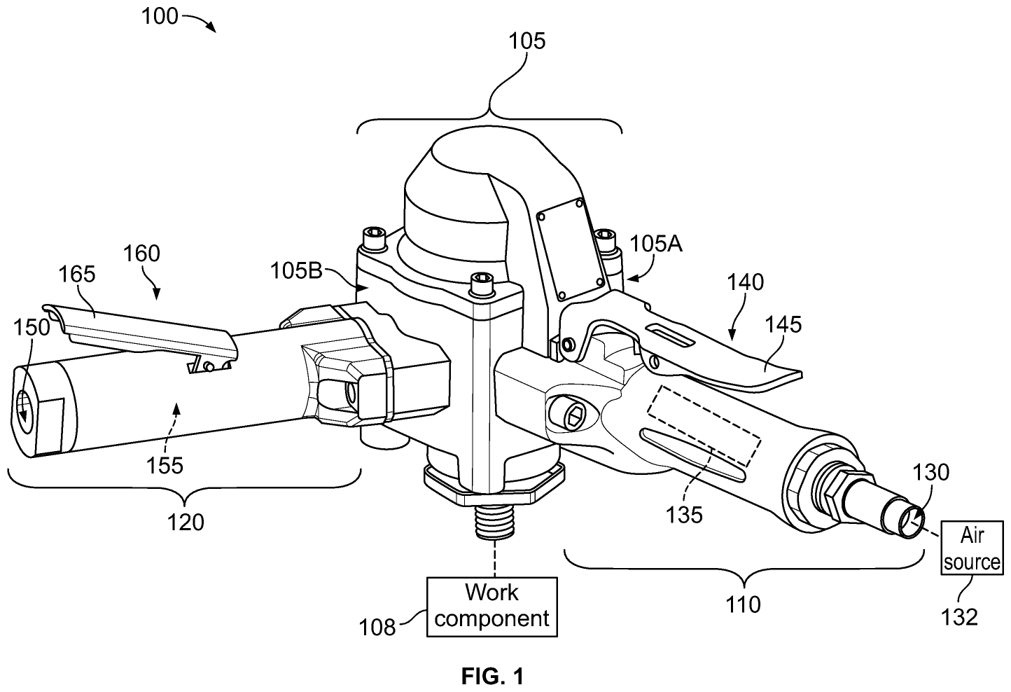

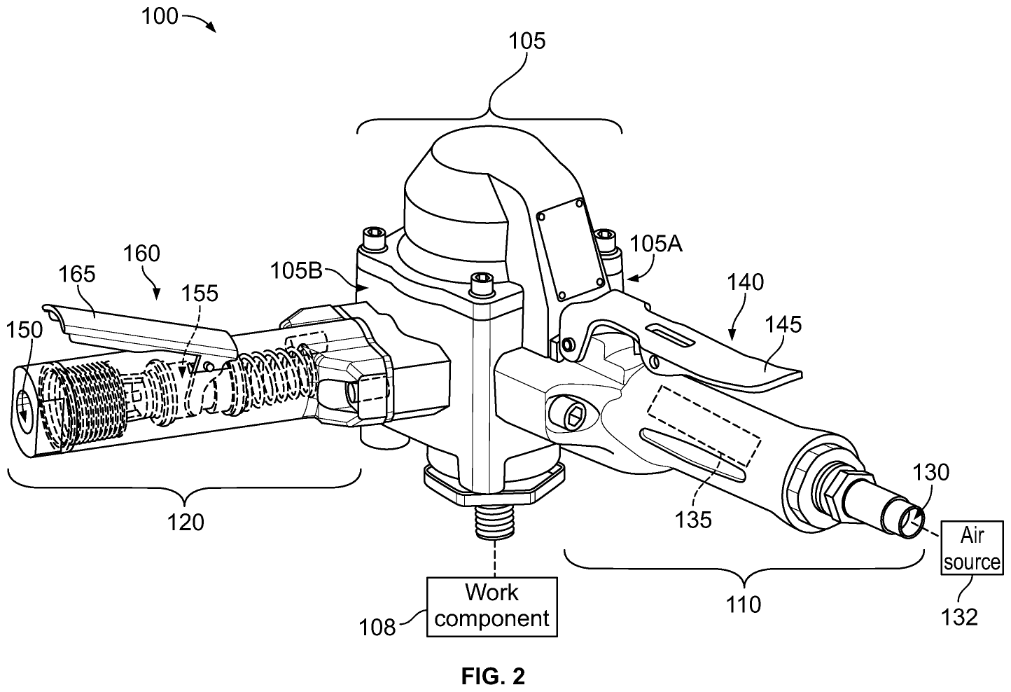

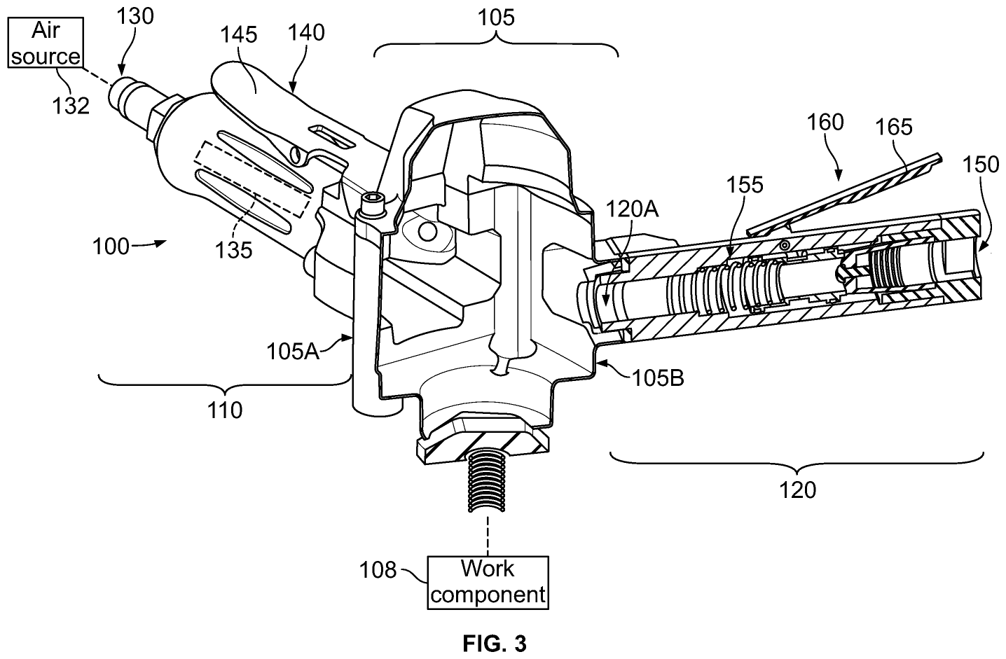

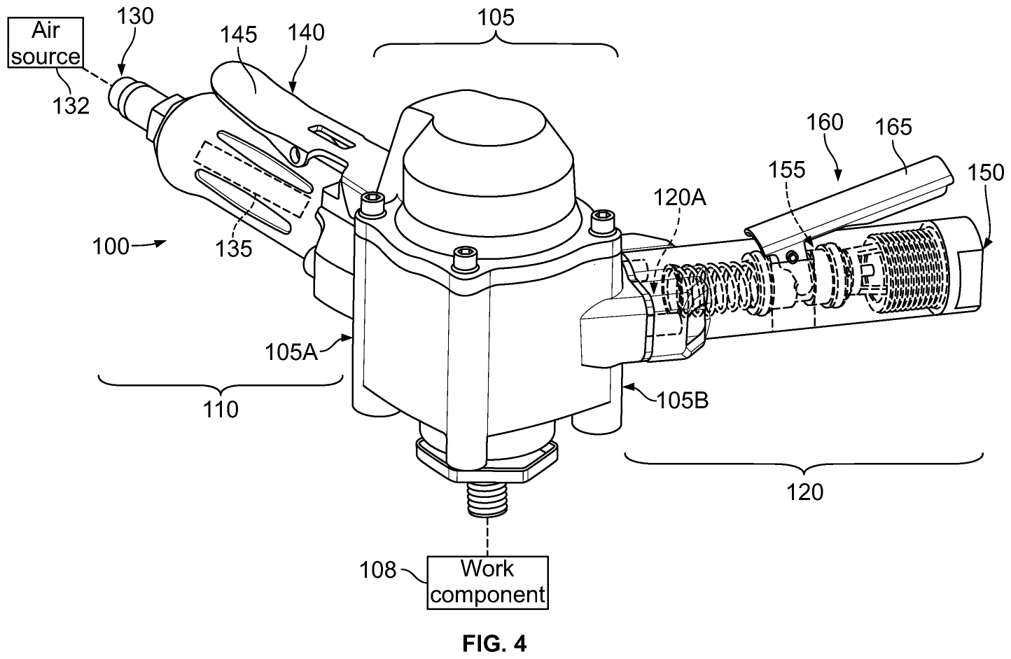

Referring now to the drawings, FIGS. 1-4 illustrate a pneumatic tool 100 (hereinafter “tool 100”) according to embodiments. The tool 100 includes a body portion 105 and at least one work component 108 coupled to the body portion 105, which work component 108 is schematically shown in FIGS. 1-4. The body portion 105 may include traditional hardware for driving the at least one work component 108. Such hardware will be apparent to one having ordinary skill in the art and will not be discussed in detail herein.

The tool 100 further comprises a first handle 110 extending from a first side 105A of the body portion 105, and a second handle 120 extending from a second side 105B of the body portion 105. The first and second handles 110, 120 extend from adjacent sides 105A, 105B of the body portion 105 in the embodiment shown, although the first and second handles 110, 120 could extend from opposed sides of the body portion 105 according to some embodiments.

The tool 100 additionally comprises an inlet port 130 for introducing air to the body portion 105 from an air source 132, such as an air compressor. The inlet port 130 includes an inlet valve mechanism 135, which may comprise a spring valve assembly that is biased toward a closed position, although other types of valves may be used as desired. While the spring valve assembly is in the closed position, air is not able to be delivered to the body portion 105 via the inlet port 130. The spring valve assembly of the inlet valve mechanism 135 may have a conventional configuration and will be apparent to one having ordinary skill in the art.

The inlet port 130 further includes a first actuator 140, also referred to herein as an inlet port actuator, that can be actuated by an operator to open the inlet valve mechanism 135 such that the air can be delivered from the air source 132 into the body portion 105 via the inlet port 130. According to embodiments, the inlet port 130 may be provided in the first handle 110, and the first actuator 140 may comprise a lever 145 that is located on the first handle 110. The lever 145 can be actuated by the operator to open the spring valve assembly while the operator is grasping the first handle 110 while using the tool 100. Since air is required to operate the tool 100, the tool 100 according to embodiments can only be operated while the operator is grasping the first handle 110 and actuating the first actuator 140, i.e., such that air is able to be delivered to the body portion 105 via the inlet port 130. The first actuator 140 could take other forms than the lever 145 shown in FIGS. 1-4, such as a button, switch, or the like.

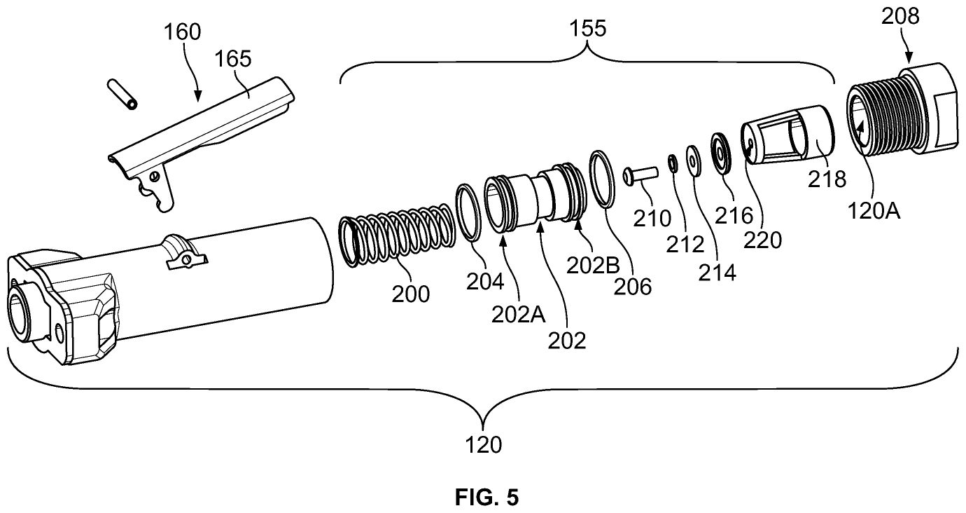

The tool 100 additionally comprises an exhaust port 150 that communicates with an exhaust opening 120A in the body portion 105 for discharging air from the body portion 105. The exhaust port 150 includes an outlet valve mechanism 155, which may comprise a spring valve assembly, see also FIG. 5, which is biased toward a closed position, although other types of valves may be used as desired. While the spring valve assembly is in the closed position, air is not able to be discharged from the body portion 105 via the exhaust port 150.

The exhaust port 150 further includes a second actuator 160, also referred to herein as an exhaust port actuator, that can be actuated by the operator to open the outlet valve mechanism 155 such that the air can be discharged from the body portion 105 via the exhaust port 150. According to embodiments, the exhaust port 150 may be provided in the second handle 120, and the second actuator 160 may comprise a lever 165 that is located on the second handle 120. The lever 165 can be actuated by the operator to open the spring valve assembly while the operator is grasping the second handle 120 while using the tool 100. According to embodiments, the body portion 105 may not include any other exhaust openings than the exhaust opening 120A associated with the second handle 120 and the tool 100 may include no other exhaust ports than the exhaust port 150 that is provided in the second handle 120. Additionally, the tool 100 may not operate, or may operate only at a reduced capacity, unless the spring valve assembly of the outlet valve mechanism 155 is in the open position to allow the discharge of air from the tool 100 via the exhaust port 150. Hence, according to embodiments, the tool 100 can only be operated (or may operate only at a reduced capacity) while the operator is grasping the second handle 120 and actuating the second actuator 160. The second actuator 160 could take other forms than the lever 165 shown in FIGS. 1-5, such as a button, switch, or the like.

With reference to FIG. 5, an outlet valve mechanism 155 according to embodiments is shown. The exemplary outlet valve mechanism 155 shown comprises a spring 200 and a valve body 202 that is actuated to open the outlet valve mechanism 155 when the operator actuates the second actuator 160. More specifically, the spring 200 is engaged with the valve body 202, which is moved when the operator actuates the second actuator 160 to compress the spring 200 and thus open the outlet valve mechanism 155. When the operator releases the second actuator 160, the valve body 202 is moved back to its resting position due to the release of the second actuator 160 and the bias of the spring 200, thus closing the outlet valve mechanism 155.

A first O-ring seal 204 is provided between a first side 202A of the valve body 202 and an interior surface within the second handle 120, and a second O-ring seal 206 is provided between a second side 202B of the valve body 202 and a connection portion 208 of the body portion 105 of the tool 100 to which the second handle 120 is attached, wherein the connection portion 208 defines the exhaust opening 120A of the body portion 105. The first and second O-ring seals 204, 206 are provided to seal the outlet valve mechanism 155 when it is in a closed position.

The outlet valve mechanism 155 shown in FIG. 5 additionally comprises a screw 210, a lock washer 212, a flat washer 214, a resilient washer 216 (e.g., formed from rubber), and a spacer member 218. The screw 210 secures the washers 212, 214, 216 to the spacer member 218. The spacer member 218 extends from the body portion 105 of the tool 100 within the connection portion 208 and includes an aperture 220 through which air is exhausted from the body portion 105 into the second handle 120. It is understood that the outlet valve mechanism 155 is exemplary and could take other forms.

Since both the first and second actuators 140, 160 are required to be actuated for full operation of the tool 100, i.e., the first actuator 140 must be actuated to allow for the introduction of air into the body portion 105 via the inlet port 130, and the second actuator 160 must be actuated to allow for the discharge of air from the body portion 105 via the exhaust port 150, the operator is thus required to grasp both the first and second handles 110, 120 to activate the first and second actuators 140, 160 for full operation of the tool 100.

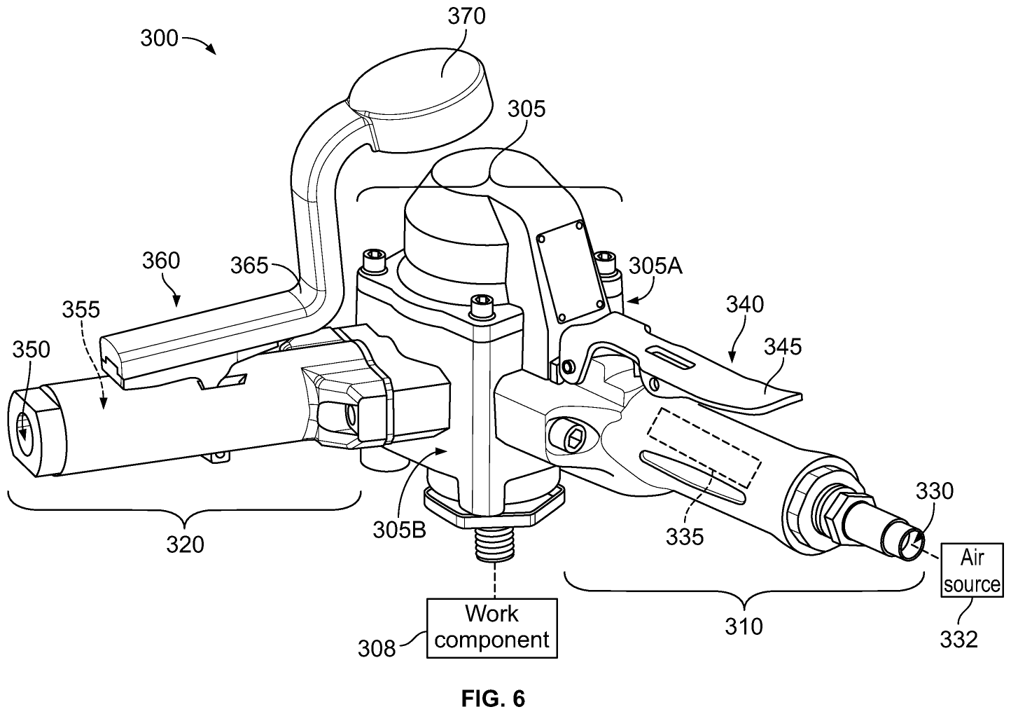

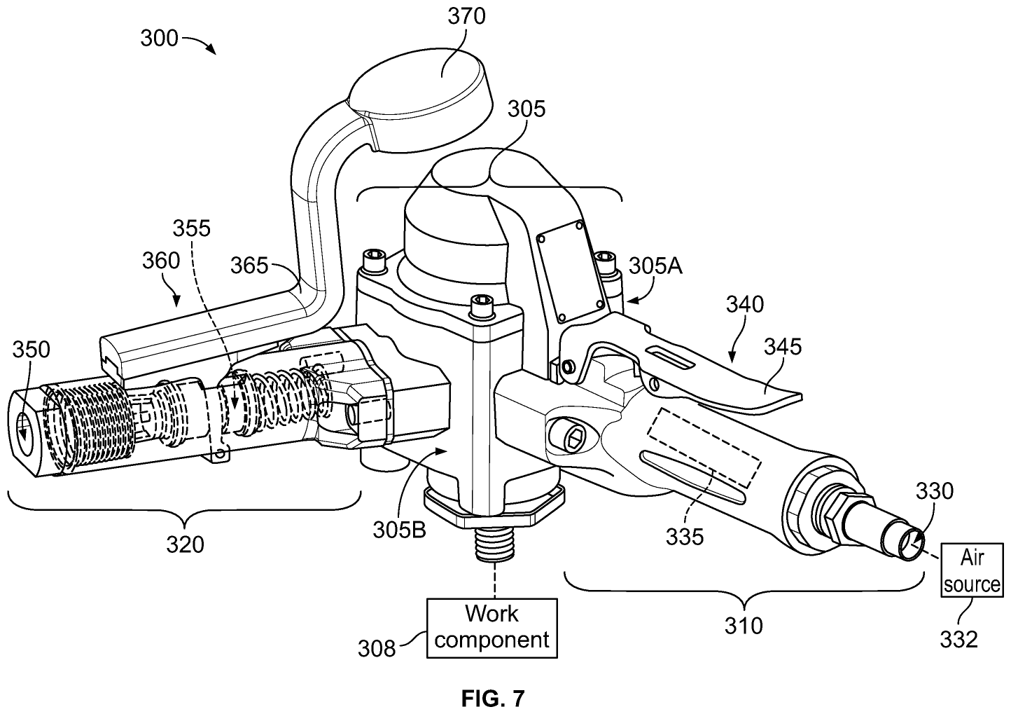

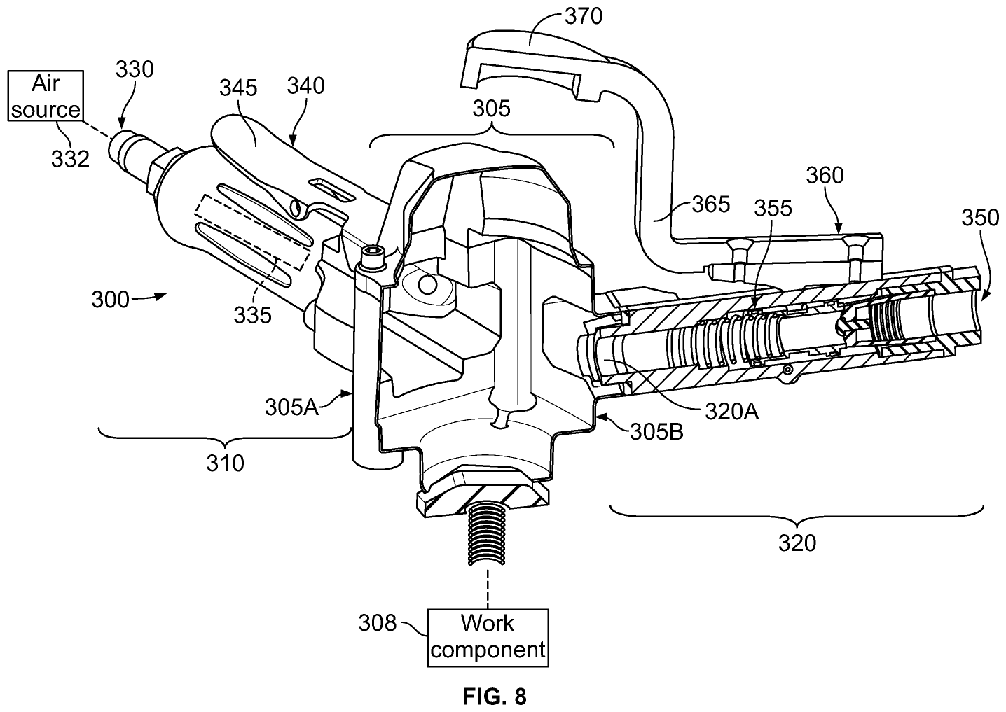

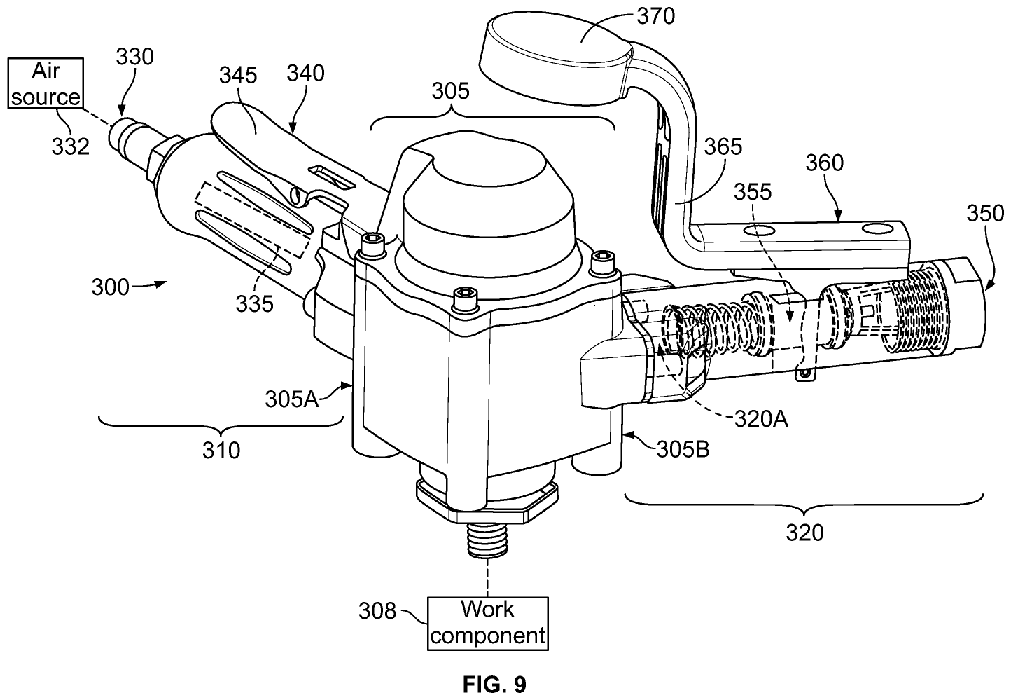

With reference now to FIGS. 6-9, a pneumatic tool 300 (hereinafter “tool 300”) according to additional embodiments is shown, where structure of the tool 300 that corresponds to the structure of the tool 100 described above for FIGS. 1-5 includes the same reference number increased by 200. Structure of the tool 300 not specifically discussed for the present embodiment may be the same as described above for the embodiment of FIGS. 1-5. The tool 300 includes a body portion 305 and at least one work component 308 coupled to the body portion 305, which work component 308 is schematically shown in FIGS. 6-9. The body portion 305 may include traditional hardware for driving the at least one work component 308. Such hardware will be apparent to one having ordinary skill in the art and will not be discussed in detail herein.

The tool 300 includes a first handle 310 and a second handle 320 located on an adjacent side of the body portion 305 from the first handle 310, although it is noted that the first and second handles 310, 320 could extend from opposed sides of the body portion 305 in some embodiments. The first handle 310 and an inlet port 330 of the tool 300, as well as an air source 332, are similar to those described above for FIGS. 1-4 and will not be described here for brevity.

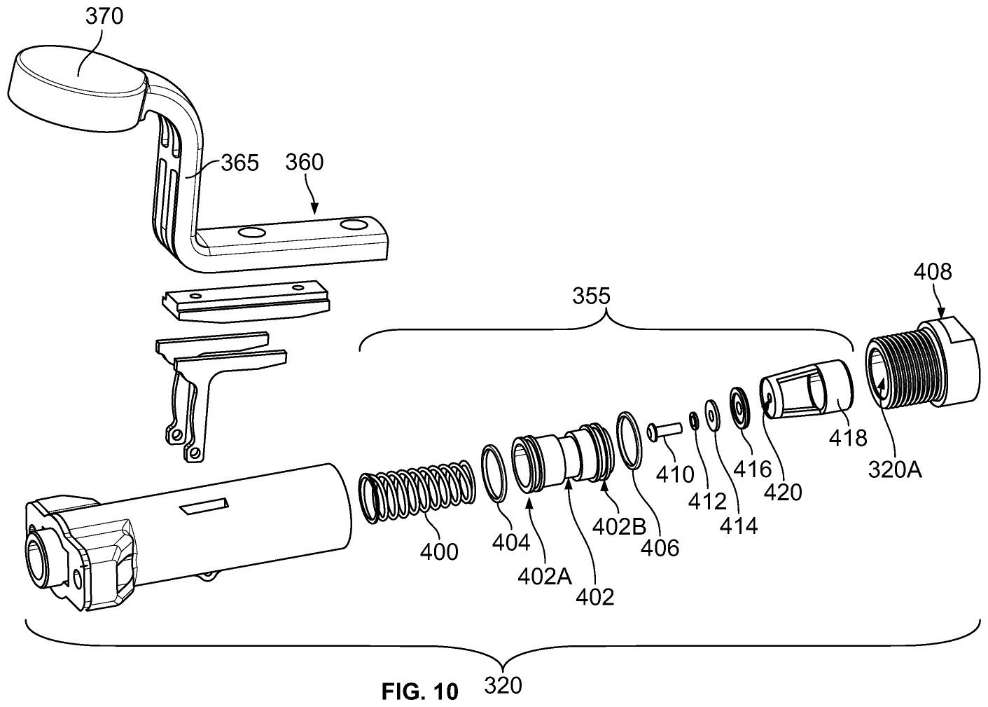

The tool 300 further comprises an exhaust port 350 for discharging air from the body portion 305. The exhaust port 350 includes an outlet valve mechanism 355, which may comprise a spring valve assembly, see also FIG. 10 (the outlet valve mechanism of FIG. 10 may be the same as discussed above with reference to FIG. 5), which is biased toward a closed position, although other types of valves may be used as desired. While the spring valve assembly is in the closed position, air is not able to be discharged from the body portion 305 via the exhaust port 350.

The exhaust port 350 further includes a second actuator 360, also referred to herein as an exhaust port actuator, that can be actuated by the operator to open the outlet valve mechanism 355 such that the air can be discharged from the body portion 305 via the exhaust port 350. According to embodiments, the exhaust port 350 may be provided in the second handle 320, and the second actuator 360 may comprise an arm member 365 that may be coupled to the second handle 320 as shown in FIGS. 6-9. The arm member 365 according to this embodiment comprises a top portion 370 that is located above the body portion 305, at or near the center of the tool 300. The second actuator 360 can be actuated by the operator to open the spring valve assembly while the operator is applying a downward force on the top portion 370 while using the tool 100. According to embodiments, the body portion 305 may not include any other exhaust openings than the exhaust opening 320A associated with the second handle 320 and the tool 300 may include no other exhaust ports than the exhaust port 350 that is provided in the second handle 320. Additionally, the tool 300 may not operate, or may operate only at a reduced capacity, unless the spring valve assembly of the outlet valve mechanism 355 is in the open position to allow the discharge of air from the body portion 305 via the exhaust port 350. Hence, according to embodiments, the tool 300 can only be operated (or may operate only at a reduced capacity) while the operator is using their hand to apply a downward force on the top portion 370 and thus actuating the second actuator 360.

Since both the first and second actuators 340, 360 (the first actuator 340 is also referred to herein as an inlet port actuator) are required to be actuated for full operation of the tool 300, i.e., the first actuator 340 must be actuated to allow for the introduction of air into the body portion 305 via the inlet port 330, and the second actuator 360 must be actuated to allow for the discharge of air from the body portion 305 via the exhaust port 350, the operator is thus required to use both hands, with one grasping the first handle 310 and the other pushing down on the top portion 370 of the arm member 365 to activate the first and second actuators 340, 360 for full operation of the tool 100.

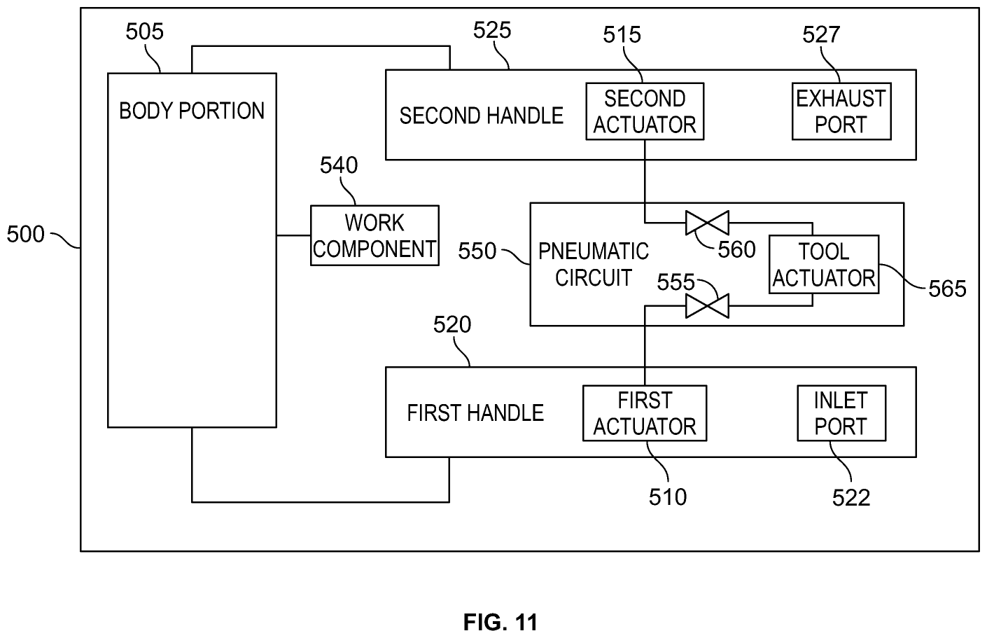

With reference now to FIG. 11, a pneumatic tool 500 according to embodiments may include a body portion 505, a first actuator 510, and a second actuator 515. These components may be similar to the body portion and first and second actuators according to the embodiments described above for FIGS. 1-4 and/or 6-9 and will not be repeated here for brevity.

The first actuator 510 may be located on a first handle 520 of the tool 500, wherein the first handle 520 may be coupled to a first side of the body portion 505 and may include an inlet port 522 for delivering air to the body portion 505. The second actuator 515 may be located on a second handle 525 of the tool 500, wherein the second handle 525 may be coupled to a second side of the body portion 505 adjacent to or opposed from the first side. The second handle 525 may include an exhaust port 527 for discharging air from the body portion 505. As with the embodiments described above, the body portion 505 may include no other exhaust openings than one associated with the second handle 525 and the tool 500 may include no other exhaust ports than the one provided in the second handle 525. The second actuator 515 according to this embodiment may take the form of either the second actuator 160 according to the embodiment of FIGS. 1-5, or the second actuator 360 according to the embodiment of FIGS. 6-10.

The tool 500 additionally comprises at least one work component 540 coupled to the body portion 505, which work component 540 is schematically shown in FIG. 11.

The tool 500 may further comprise a pneumatic circuit 550 comprising an inlet valve mechanism 555 for introducing air into the body portion 505 via the inlet port 522, an outlet valve mechanism 560 for discharging air from the body portion 505 via the exhaust port 527, and a tool actuator 565. The inlet valve mechanism 555 is coupled to the first actuator 510, and the outlet valve mechanism 560 is coupled to the second actuator 515. The inlet and outlet valve mechanisms 555, 560 may be similar to those discussed above for FIGS. 1-4 and 6-9 and thus will not be described here for brevity.

The first and second actuators 510, 515 are both actuated to open the respective inlet and outlet valve mechanisms 555, 560 and thus activate the tool actuator 565, which must be activated for full operation of the tool 500, i.e., the tool 500 will not operate, or will operate only at a reduced capacity, unless the tool actuator 565 is activated by actuating both the first and second actuators 510, 515.

According to embodiments, the work component 108, 308, 540 of the pneumatic tools 100, 300, 500 disclosed herein may be, for example, a sander, nail gun, stapler, drill, paint sprayer, grinder, impact wrench, air ratchet, shear, hammer gun, sandblaster, etc. It is understood that other types of work components could be used with the pneumatic tools 100, 300, 500 disclosed herein as desired. It is also understood that the tools 100, 300, 500 disclosed herein could be designed to use interchangeable work components, where a user could select a specific work component from a group of work components for a particular use and releasably connect it to the body portion 105, 305, 505 of the tool 100, 300, 500 in a conventional manner.

Embodiments disclosed herein promote the proper use of a pneumatic tool by requiring an operator to use both hands on the tool for full operation thereof. According to embodiments, two actuators that are respectively associated with separate handles of the tool require the operator to use each hand on a corresponding actuator for full operation of the tool. Hence, injury that may result from improper use of a pneumatic tool with only one hand may be minimized or avoided.

The various features, aspects, and embodiments described herein can be used in any combination(s) with one another, or on their own.

Having thus described embodiments in detail, it will be apparent that modifications and variations are possible without departing from the scope of the appended claims.

What is claimed is:

1. A pneumatic tool comprising:
a body portion;
an inlet port for delivering air to the body portion;
a first handle coupled to the body portion; and
a second handle coupled to the body portion and comprising an exhaust port for discharging air from the body portion.

2. The pneumatic tool of claim 1, wherein the exhaust port comprises an outlet valve mechanism and an exhaust port actuator that is actuatable by an operator to open the outlet valve mechanism such that the air can be discharged from the exhaust port.

3. The pneumatic tool of claim 2, wherein the exhaust port actuator comprises a lever located on the second handle.

4. The pneumatic tool of claim 2, wherein the exhaust port actuator comprises an arm member having a top portion that is located above the body portion.

5. The pneumatic tool of claim 2, wherein the outlet valve mechanism comprises a spring valve assembly that is biased toward a closed position unless the exhaust port actuator is being actuated by the operator.

6. The pneumatic tool of claim 2, wherein the pneumatic tool does not operate or operates at a reduced capacity if the exhaust port actuator is not being actuated by the operator.

7. The pneumatic tool of claim 1, wherein the tool comprises no other exhaust ports than the one provided in the second handle.

8. The pneumatic tool of claim 1, wherein the inlet port is provided in the first handle.

9. The pneumatic tool of claim 8, wherein the inlet port comprises an inlet valve mechanism and an inlet port actuator that is actuatable by an operator to open the inlet valve mechanism such that the air can be delivered into the body portion via the inlet port.

10. The pneumatic tool of claim 9, wherein the inlet port actuator comprises a lever located on the first handle.

11. The pneumatic tool of claim 9, wherein the inlet valve mechanism comprises a spring valve assembly that is biased toward a closed position unless the inlet port actuator is being actuated by the operator.

12. The pneumatic tool of claim 1, further comprising a work component coupled to the body portion.

13. The pneumatic tool of claim 1, wherein the first and second handles respectively extend from different sides of the body portion.

14. A pneumatic tool comprising:
a body portion;
a first actuator;
a second actuator; and
a pneumatic circuit comprising an inlet valve mechanism for introducing air into the body portion, an outlet valve mechanism for discharging air from the body portion, and a tool actuator;
wherein:
the first actuator is coupled to the inlet valve mechanism;
the second actuator is coupled to the outlet valve mechanism; and
the first actuator and second actuator are both actuated to activate the tool actuator.

15. The pneumatic tool of claim 14, wherein:
the outlet valve mechanism comprises a spring valve assembly that is biased toward a closed position unless the second actuator is being actuated by an operator; and
the inlet valve mechanism comprises a spring valve assembly that is biased toward a closed position unless the first actuator is being actuated by an operator.

16. The pneumatic tool of claim 14, further comprising:
a first handle coupled to the body portion on a first side thereof, wherein the first actuator is located on the first handle; and
a second handle coupled to the body portion on a second side thereof different than the first side, wherein the second actuator is located on the second handle.

17. The pneumatic tool of claim 16, wherein:
the first handle includes an inlet port for delivering air to the body portion;
the second handle includes an exhaust port for discharging air from the body portion; and
the tool comprises no other exhaust ports than the one provided in the second handle.

18. The pneumatic tool of claim 14, wherein the second actuator comprises one of: a lever; or
an arm member having a top portion that is located above the body portion.

19. A handle for a pneumatic tool comprising:
an exhaust port for communication with an exhaust opening in the pneumatic tool, the exhaust port comprising:
an outlet valve mechanism; and
an actuator that is actuatable by an operator to open the outlet valve mechanism such that air from the tool can be discharged from the exhaust port.

20. The handle of claim 19, wherein the outlet valve mechanism comprises a spring valve assembly that is biased toward a closed position unless the actuator is being actuated by the operator.
